(19) United States
(12) Patent Application Publication
(10) Pub. No.: US 2010/0320247 A1
(43) Pub. Date: Dec. 23, 2010

(54) Bike Carrier

(76) Inventors: Kun-Chieh Wang, Taichung City (TW); Jung-Chin Liang, Chang Hua City (TW); David TSAI, Chang Hua City (TW)

Correspondence Address: Dr. BANGER SHIA;Patent Office of Bang Shia, 102 Lindencrest Ct, Sugar Land, TX, 77479-5201, US

(21) Appl. No.: 12/489,558

(22) Filed: Jun. 23, 2009

(51) Int. Cl. B60R 9/00

(52) U.S. Cl. 224/567

(57) ABSTRACT

A bike carrier comprises a main mount having first and second coupled ends, with the first coupled end attached to rear of a vehicle; a first cradle assembly installed to the second coupled end horizontally and adapted for positioning wheels of a bike thereon; and a second cradle assembly including a support means vertically installed at the second coupled end, at least one adjustment means slideably disposed in and being rotatable with respect to the support means and at least one wedged member adapted to fix the at least one adjustment means to a desired vertical position, so that the second cradle assembly is adapted to hook various kinds of bike because the at least one adjustment means is able to be rotated before frame of the bike is hooked thereon.

### BACKGROUND OF THE INVENTION

1. Field of the Invention

The present invention relates generally to bike carriers and more particularly to a bike carrier which includes a rotatable and lockable cradle assembly.

2. Description of the Related Art

Referring to U.S. Pat. No. 7,240,816, a rack 20 for supporting at least one bicycle in position includes a base. Two beams are pivotally connected with the base. At least one supporting device is attached to each of the beams in order to support one wheel of the bicycle. A post is pivotally connected with the base. A hooking device is attached to the post in order to hook the bicycle. However, hooks of the hooking device are secured to collars of the hooking device in a fixed manner. Hence, while the hooks of the hooking device hook upper tube of the bicycle, the hooks can not be rotated to fit various kinds of bicycles.

The present invention is, therefore, intended to obviate or at least alleviate the problems encountered in the prior art.

### SUMMARY OF THE INVENTION

The present invention is directed at providing a highly versatile bike carrier which facilitates resolving or reducing some of the problems associated with the prior art. Versatility is facilitated by providing structure which can be readily interchanged and/or repositioned for accommodating different situations faced. Further, the bike carrier includes a lock means for selectively locking the bike to the bike carrier as to prevent the bike detaching from the bike carrier while the vehicle is moving.

Other objectives, advantages, and features of the invention will become more apparent from the following detailed description when taken in conjunction with the accompanying drawings.

### BRIEF DESCRIPTION OF THE DRAWINGS

FIG. 1 is a perspective view of a bike carrier according to the preferred embodiment of the present invention.

FIG. 2 is a partial, exploded view of the bike carrier shown in FIG. 1.

FIG. 3 is a cross-sectional view of the bike carrier taken along a line 3-3 shown in FIG. 1.

FIG. 4 is a cross-sectional view of the bike carrier taken along a line 4-4 shown in FIG. 1.

FIG. 5 is a top view of the bike carrier shown in FIG. 1, illustrating operation of a first cradle assembly of the bike carrier.

FIG. 6 is another partial, cross-sectional view of the bike carrier similar to FIG. 3.

FIG. 7 is another partial, cross-sectional view of the bike carrier similar to FIG. 4.

FIG. 8 is a partial, perspective view of the bike carrier shown in FIG. 1, illustrating operation of a second cradle assembly of the bike carrier.

FIG. 9 is another partial, perspective view of the bike carrier similar to FIG. 8, illustrating rotation of the second cradle assembly of the bike carrier.

FIG. 10 is a partial, cross-sectional view of the bike carrier shown in FIG. 9.

FIG. 11 is a perspective view of the bike carrier shown in FIG. 1, illustrating that the bike carrier is used to carry a bike on a vehicle.

### DETAILED DESCRIPTION OF THE PREFERRED EMBODIMENT

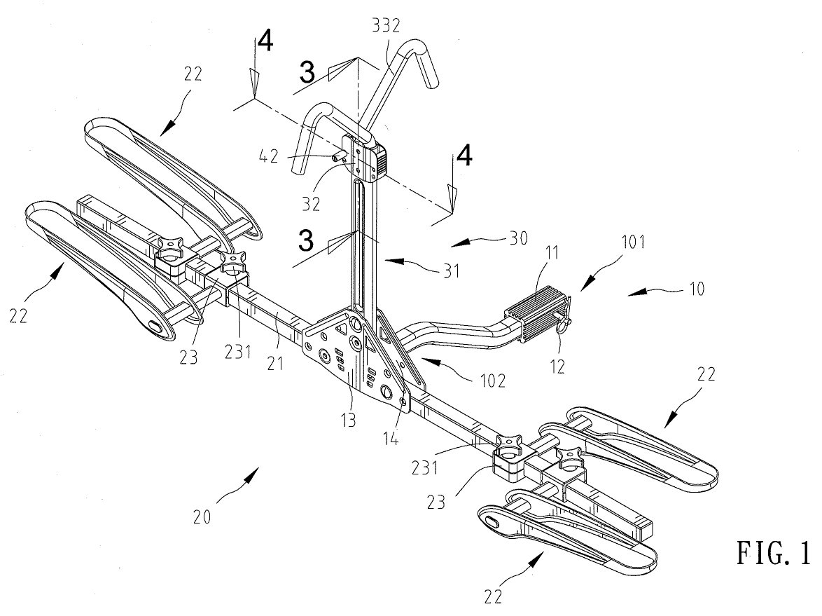

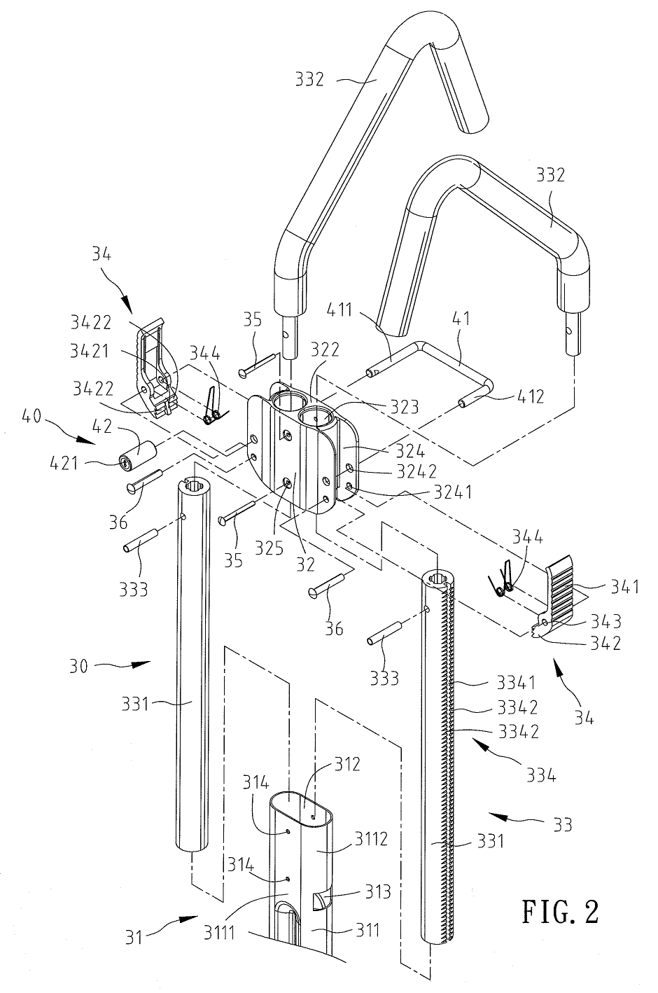

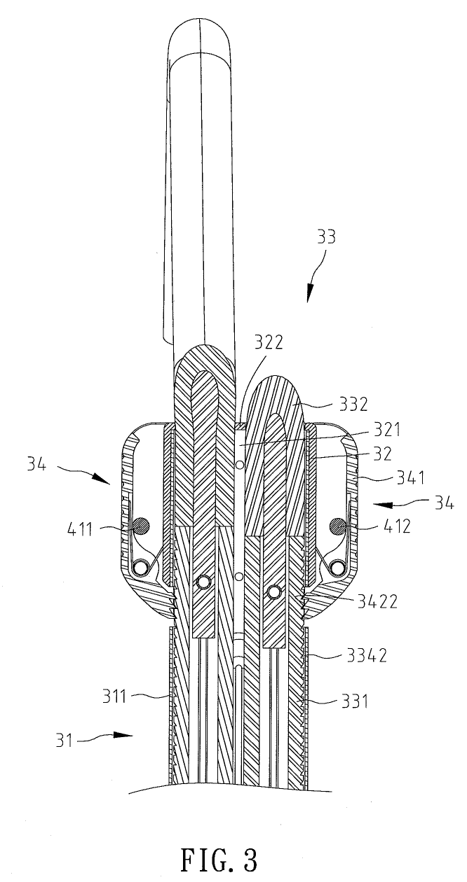

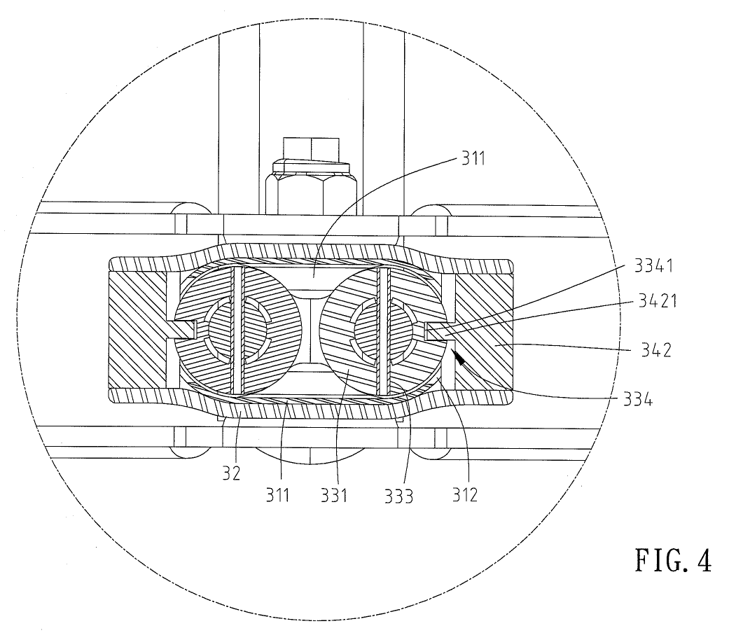

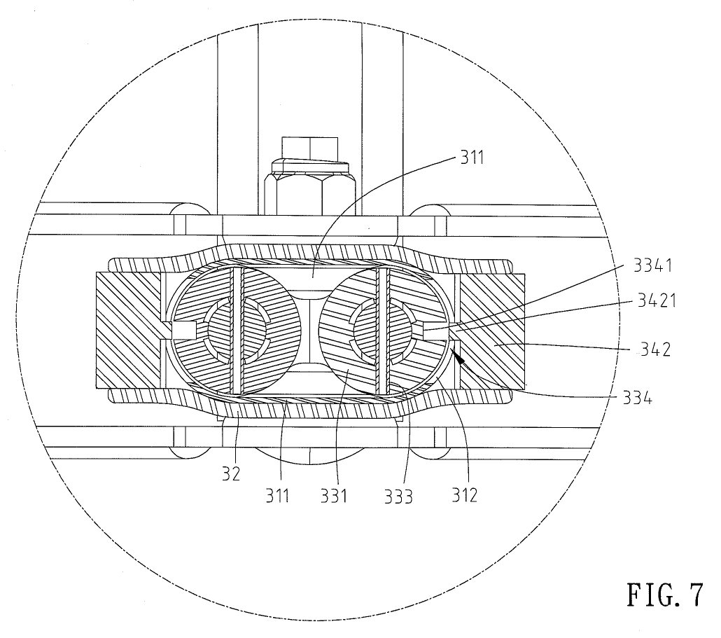

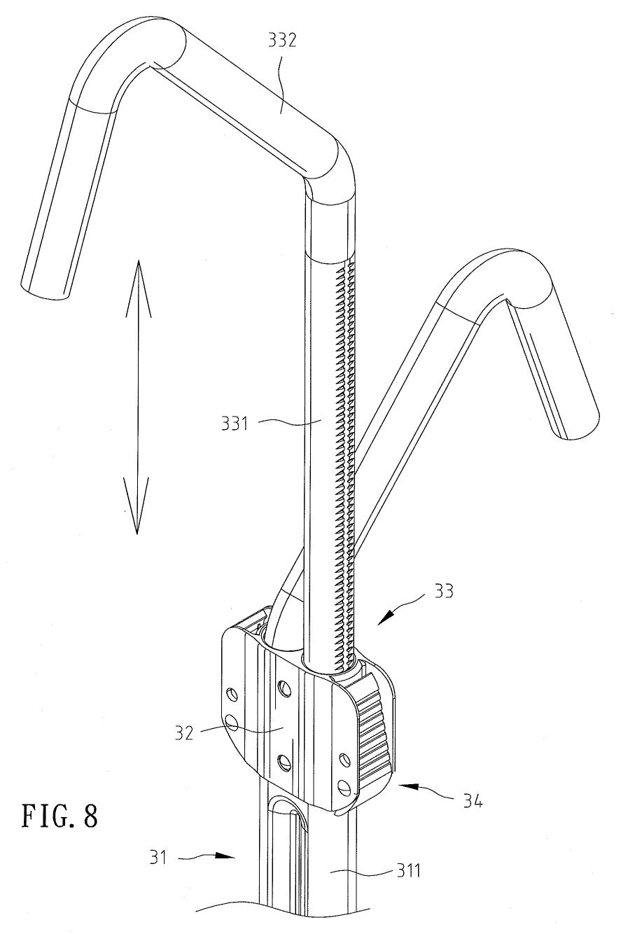

Referring to FIGS. 1 through 10, they show a bike carrier in accordance with the preferred embodiment of the present invention. The bike carrier includes a main mount 10, first and second cradle assemblies 20, 30 and a lock means 40. In use, the main mount 10 is attached to rear of a vehicle; the first cradle assembly 20 is adapted to position front and rear wheels of a bike on the bike carrier and the second cradle assembly 30 is adapted to hook frame of the bike as to secure the bike on the bike carrier; the lock means 40 is used to selectively fix the second cradle assembly 30.

The main mount 10 includes a first coupled end 101 secured to the rear of the vehicle and a second coupled end 102 opposite to the first coupled end 11 and coupled to the first and second cradle assemblies 20, 30. A mount member 11 is mounted on the first coupled end 101 and coupled to a holder (not shown) that is provided at the rear of the vehicle. A pin 12 is used to insert through the mount member 11 and the holder of the vehicle for securing the main mount 10 to the vehicle. A connective base 13 is provided at the second coupled end 102 and includes a channel 14 adapted to couple to the first and second cradle assemblies 20, 30 respectively.

The first cradle assembly 20 is installed to the connective base 13 at the second coupled end 102 and includes two side rails 21 pivotally installed to and extending from two ends of the channel 14 respectively. Two hold elements 22 are coupled to an end of each side rail 21 opposite to the connective base 13 via a tightening element 23 and provided at two sides of the end of the side rail 21. Two of the hold elements 22 which are located at the same side of the two side rails 21 are used to position first and rear wheels of a bike to the bike carrier. Each tightening element 23 is adjustably installed on the related slide rail 21 as to adjust position of the related hold elements 22 on the related slide rail 21. A knob 231 is disposed on each tightening element 23 and adapted to selectively fix the related tightening element 23 and the related hold elements 22 at a desired position on the related slide rail 21.

A second cradle assembly 30 includes a support means 31, a mount means 32, two adjustment means 33 and two wedged members 34. The support means 31 has a first end vertically inserted into the channel 14 at the connective base 13 and a second end extending from the first end and attached to the mount means 32 and includes a frame member 311 which consists of two flat surfaces 3111 and two arcuate surfaces 3112. A receptacle 312 is defined in the second end of the support means 31 and surrounded by the frame member 311. Two gaps 313 are respectively formed on the two arcuate surfaces 3112 in position and communicate with the receptacle 312. Two apertures 314 are formed on each of the two flat surfaces 3111 in vertical arrangement and adjacent to the second end of the support means 31.

The mount means 32 includes a mounted portion 321 mounted on the outer periphery of the second end of the support means 31 and a limited portion 322 abutted against top of the second end of the support means 31 while the mount means 32 is coupled to the support means 31. Two receiving portions 323 are longitudinally defined in the mount means 32 and communicate with the receptacle 312. Each receiving portion 323 has a circle cross-section. Two coupled portions 324 are provided at and opened to two sides of the mount means 32. In this case, the receiving portions 323 are parallel to each other and the coupled portions 324. A first hole 3241 and a second hole 3242 are formed at each of two sides of each coupled portion 324 in vertical arrangement. Two through-holes 325 are formed on a side of the mount means 32 and correspond to the apertures 314 formed on one flat surface 3111. Two fasteners 35 are used to engage the through-holes 325 and the related apertures 314 for attaching the mount means 32 to the support means 31.

Each adjustment means 33 includes a cylinder-shaped shaft 331 which has a first end inserted through one of the receiving portions 323 and a second end received in the receptacle 312 and a rack 332 coupled to the first end of the shaft 331 via a connecting element 333. The shafts 331 are able to slide with respect to the support means 31 longitudinally. In this case, each rack 332 is preferably being inverted V-shaped for hooking the bike frame as to fix the bike to the bike carrier and further has a smaller diameter inserted end (not numbered) which is inserted into the first end of the related shaft 331. The connecting elements 333 are adapted to connect the racks 332 and the shafts 331 to each other and prevent the racks 332 rotating with respect to the shafts 331. Each of shafts 331 forms a longitudinal positioning portion 334 on a side thereof opposite to the other shaft 331. A longitudinal groove 3341 is formed on the center of the positioning portion 334 and two positioning arrays 3342 are respectively longitudinally formed on two sides of the groove 3341 and parallel to one another. Two plurality of teeth (not numbered) are respectively formed on the two positioning arrays 3342.

The two wedged members 34 are respectively pivotally connected to the coupled portions 324 of the mount means 32. Each wedged member 34 includes a pressed end 341, a wedged end 342 opposite to the pressed end 341 and a pivotal portion 343 defined between the pressed and wedged ends 341, 342 and being adjacent to the wedged end 342. The pivotal portion 343 is disposed between the sides of the coupled portions 324 defines a hole (not numbered) pivotally connected to the first holes 3241 of the coupled portions 324 via one fastener 36 inserted through the hole of the pivotal portion 343 and the first holes 3241 of the coupled portions 324. The pressed end 341 is adapted to be pressed by users as to selectively engage the wedged end 342 with the positioning portion 334 of the related adjustment means 33 via the gaps 313. The wedged end 342 includes a plurality of fixed teeth 3422 formed thereon and corresponding to and engaged with teeth of the positioning arrays 3342 for fixing the related adjustment means 33 in a desired vertical position. And a sliding portion 3421 projects from the center of the fixed teeth 3422 and is selectively embedded in the groove 3341 for fixing each wedged member 34 to the related adjustment means 33 as to restrict rotatation of the related adjustment means 33 and fix the related adjustment means 33 in vertical position. An elastic element 344, which is provided between the two sides of the coupled portion 324 and inserted by the fastener 36, presses the pressed end 341 outward as to drive the wedged end 342 to engage with the positioning portion 334 of the adjustment means 33.

The lock means 40 includes a fixed member 41 and a locking member 42. In this embodiment, the fixed member 41 is approximately U-shaped and has first and second legs 411, 412 which are respectively inserted the second holes 3242 of the two coupled portions 324 and press the pressed ends 341 of the two wedged members 34 to drive the wedged members 34 to engage with the adjustment means 33. In this case, length of the first leg 411 is larger than that of the second leg 412 so that the first leg 411 extends out of the mount means 32 and coupled to the locking member 42. The locking member 42 has a lock 421 formed at an end thereof opposite to the first leg 411, hence, users can use a key or password to actuate the lock 421 for fixing the lock means 40 to the mount means 32.

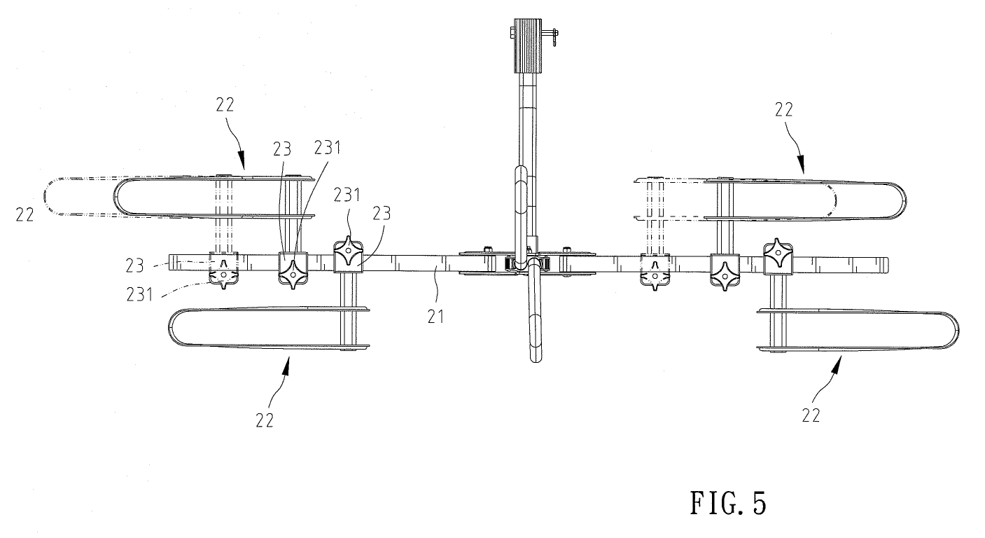

Referring to FIG. 5, each hold element 22 is able to slide along the related side rail 21 to adjust the position of each hold element 22 with respect to the related side rail 21.

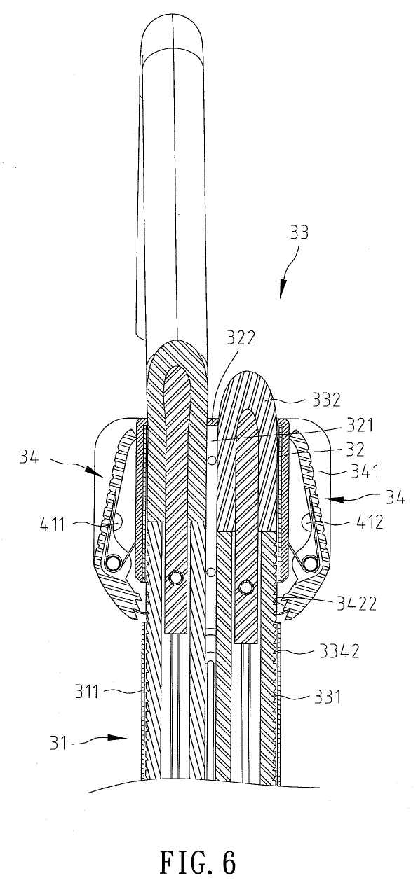

Referring to FIGS. 6 through 8, while adjusting the vertical position of the adjustment means 33 with respect to the mount means 32, the pressed ends 341 of the wedged members 34 are pressed as to disengage the wedged ends 342 of the wedged members 34 from the positioning portions 334 of the adjusting means 33. After the adjusting means 33 are adjusted to be in position, the pressed ends 341 of the wedged members 34 are loosened by users and the elastic elements 344 are pressed toward the pressed ends 341 so that the wedged ends 342 are engaged with the positioning portion 334 and the adjusting means 33 are fixed in the desired position. The second cradle assembly 30 is adapted to hook various kinds of bike because the adjustment means 33 are able to be rotated before frame of the bike is hooked thereon.

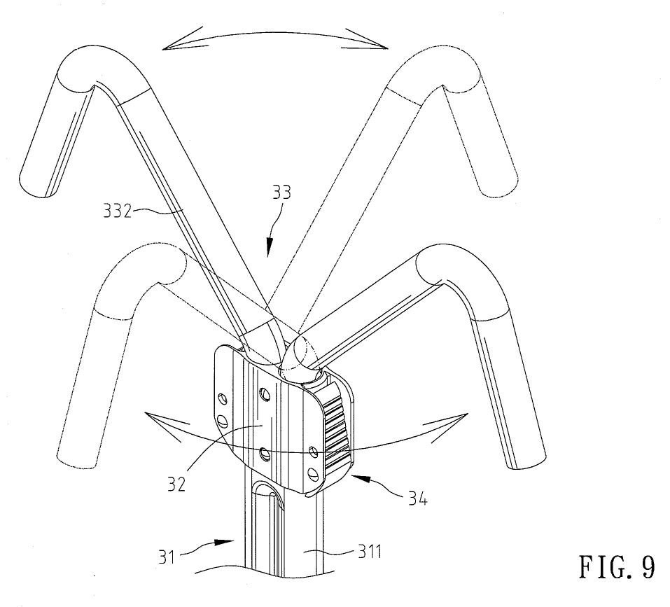

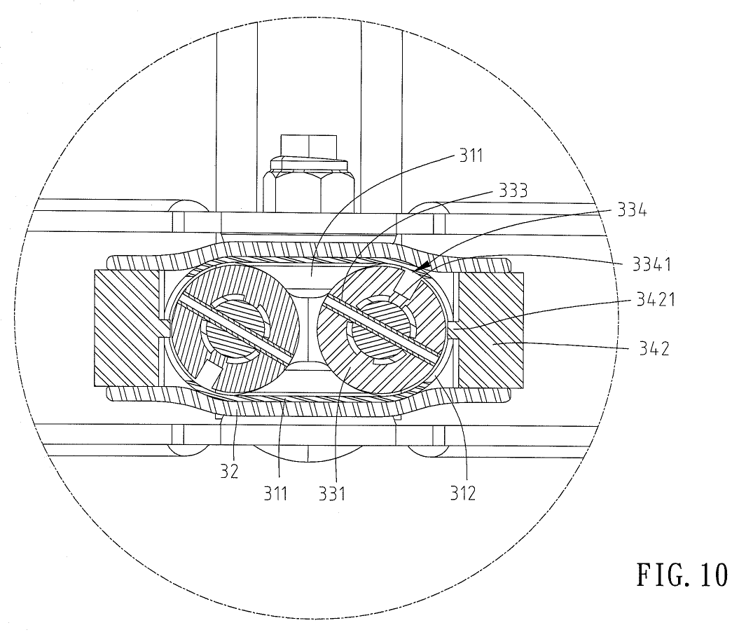

Referring to FIGS. 9 and 10, even if the adjusting means 33 are fixed to the mount means 32, the adjusting means 33 are still able to rotate with respect to the support means 31 freely. Therefore, it is easy and convenient to set the bike at the first cradle assembly 20 by rotating the adjusting means 33; and then rotating the adjusting means 33 again, the bike is secured at the first cradle assembly 20 (shown in FIG. 1). Further, as the adjusting means 33 are being rotated, the wedged ends 342 of the wedged members 34 is abutted against the outer periphery of the shafts 331. And after the positioning portions 334 are rotated to be aligned the wedged ends 342 of the wedged members 34, the adjusting means 33 are able to be engaged with the positioning portions 334 automatically.

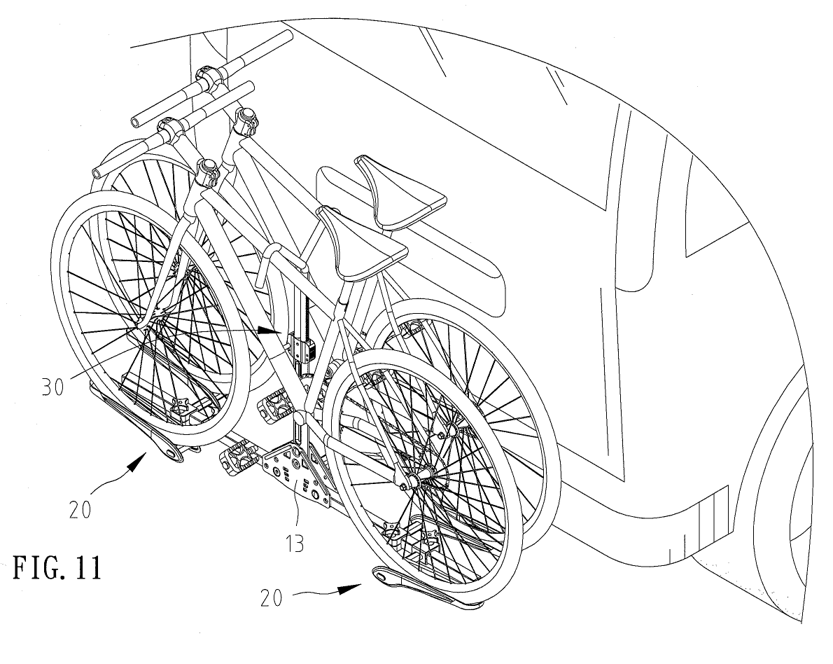

Referring to FIG. 11, the bike carrier is attached to the rear of the vehicle, and the bike is firmly secured at the bike carrier. The front and rear wheels of the bike are respectively positioned at the first cradle assembly 20 and the second cradle assembly 30 is fixed to the bike frame.

While several embodiments of the invention have been shown and described, it will be apparent to those skilled in the art that modifications may be made therein without departing from the scope and spirit of the present invention.

What is claimed is:

1. A bike carrier comprising:
a main mount having first and second coupled ends, with the first coupled end attached to rear of a vehicle;
a first cradle assembly installed to the second coupled end horizontally and adapted for positioning wheels of a bike thereon; and
a second cradle assembly including a support means vertically installed at the second coupled end, at least one adjustment means slideably disposed in and being rotatable with respect to the support means and at least one wedged member adapted to fix the at least one adjustment means to a desired vertical position, so that the second cradle assembly is adapted to hook various kinds of bike because the at least one adjustment means is able to be rotated before frame of the bike is hooked thereon.

2. The bike carrier as claimed in claim 1 further comprising a lock means adapted to selectively fix the support means to the at least one adjustment means in the desired vertical position.

3. The bike carrier as claimed in claim 1, wherein the at least one of adjustment means defines a longitudinal positioning portion formed a side thereof; wherein the at least one wedged member has a pressed end and a wedged end selectively engaged with the positioning portion.

4. The bike carrier as claimed in claim 3 further comprising a groove formed on the center of the positioning portion and a sliding portion projects from the center of the wedged end and selectively embedded in the groove.

5. The bike carrier as claimed in claim 4 further comprising two positioning arrays transversely formed on two sides of the groove and parallel to one another, and a plurality of fixed teeth formed on the wedged end and corresponding to and embedded into the positioning arrays, with the sliding portion projects from the center of the fixed teeth.

6. The bike carrier as claimed in claim 3 wherein the at least one adjustment means includes a shaft which has a first end and a second end received in the support means and a rack coupled to the first end of the shaft and adapted to hook the bike frame, with the positioning portion provided on a side of the shaft.

7. The bike carrier as claimed in claim 1 further comprising a mount means attached to the support means; wherein the support means includes a frame member vertically installed to the second coupled end of the main mount, with the mount means provided between the frame member and the at least one adjustment means, with the at least one the wedged member provided at a side of the mount means and corresponding to the at least one adjustment means, and with the at least one the wedged member selectively engaged with the at least one adjustment means.

8. The bike carrier as claimed in claim 7, wherein the mount means includes a mounted portion mounted on the outer periphery of the support means, a limited portion abutted against top of the support means while the mount means is coupled to the support means, and at least one receiving portion longitudinally defined in the mount means and communicate with interior of the support means, with the at least one adjustment means inserted through the at least one receiving portion.

9. The bike carrier as claimed in claim 8 further comprising at least one gap formed on periphery of the support means and corresponding to the wedged end and communicate with interior of the support means.

10. The bike carrier as claimed in claim 9, further comprising at least one coupled portion provided at and opened to the side of the mount means and corresponding to the gap; wherein the coupled portion forms a first hole and a second hole on each side thereof in vertical arrangement; wherein the at least on of wedged member includes a pivotal portion between the pressed and wedged ends pivotally connected to the first holes.

11. The bike carrier as claimed in claim 3, wherein numbers of the adjustment means is two and the at least one adjustment means define a longitudinal positioning portion formed a side thereof; wherein numbers of the wedged member is two and each wedged member has a pressed end and a wedged end selectively engaged with the positioning portion.

12. The bike carrier as claimed in claim 11 further comprising a groove formed on the center of the positioning portion and a sliding portion projects from the center of the wedged end and selectively embedded in the groove.

13. The bike carrier as claimed in claim 12 further comprising two positioning arrays transversely formed on two sides of the groove and parallel to one another, and a plurality of fixed teeth formed on the wedged end and corresponding to and embedded into the positioning arrays, with the sliding portion projects from the center of the fixed teeth.

14. The bike carrier as claimed in claim 11 wherein each adjustment means include a shaft which has a first end and a second end received in the support means and a rack coupled to the first end of the shaft and adapted to hook the bike frame, with the positioning portion provided on a side of the shaft.

15. The bike carrier as claimed in claim 2 further comprising a mount means attached to the support means; wherein the support means includes a frame member vertically installed to the second coupled end of the main mount, with the mount means provided between the frame member and the adjustment means, with the wedged members provided at two sides of the mount means and corresponding to the adjustment means, and with the wedged members selectively engaged with the at least one adjustment means, respectively.

16. The bike carrier as claimed in claim 15, wherein the mount means includes a mounted portion mounted on the outer periphery of the support means, a limited portion abutted against top of the support means while the mount means is coupled to the support means, and two receiving portions longitudinally defined in the mount means and communicate with interior of the support means, with the two adjustment means inserted through the two receiving portions.

17. The bike carrier as claimed in claim 16 further comprising two gaps formed on periphery of two sides of the support means and corresponding to the wedged ends and communicate with interior of the support means.

18. The bike carrier as claimed in claim 17, further comprising two coupled portions provided at and opened to the two sides of the mount means and corresponding to the gaps; wherein the coupled portion forms a first hole and a second hole on each side thereof in vertical arrangement; wherein each wedged member includes a pivotal portion between the pressed and wedged ends pivotally connected to the first holes.

19. The bike carrier as claimed in claim 18 wherein the lock means includes a fixed member having first and second legs and a locking member, with the first and second legs respectively inserted through the second holes and abutted against the pressed ends; wherein the first leg extends out of the mount means and coupled to the locking member.

20. The bike carrier as claimed in claim 10 further comprising an elastic element provided between the two sides of the coupled portion and presses the pressed end outward as to drive the wedged end to engage with the positioning portion of the adjustment means.

21. The bike carrier as claimed in claim 15 further comprising an elastic element provided between the two sides of the coupled portion and presses the pressed end outward as to drive the wedged end to engage with the positioning portion of the adjustment means.

22. The bike carrier as claimed in claim 1 further comprising a connective base provided at the second coupled end of the main mount and includes a channel adapted to couple to the first and second cradle assemblies respectively.

23. The bike carrier as claimed in claim 2 further comprising a connective base provided at the second coupled end of the main mount and includes a channel adapted to couple to the first and second cradle assemblies respectively.

24. The bike carrier as claimed in claim 22 wherein the first cradle assembly includes two side rails pivotally installed to and extending from two ends of the channel respectively and two hold elements are coupled to an end of each side rail opposite to the connective base via a tightening element and provided at two sides of the end of the side rail; wherein two of the hold elements which are located at the same side of the two side rails are used to position first and rear wheels of a bike to the bike carrier.

25. The bike carrier as claimed in claim 23 wherein the first cradle assembly includes two side rails pivotally installed to and extending from two ends of the channel respectively and two hold elements are coupled to an end of each side rail opposite to the connective base via a tightening element and provided at two sides of the end of the side rail; wherein two of the hold elements which are located at the same side of the two side rails are used to position first and rear wheels of a bike to the bike carrier.

26. The bike carrier as claimed in claim 1 wherein the at least one adjustment means is able to be rotated with respect to the support means.

27. The bike carrier as claimed in claim 1 wherein the adjustment means are able to be rotated with respect to the support means.
